(19) United States
(12) Patent Application Publication
(10) Pub. No.: US 2013/0322951 A1
(43) Pub. Date: Dec. 5, 2013

(54) Stylus Structure

(71) Applicant: Shan-Tien Hwang, Taipei City (TW)

(72) Inventor: Shan-Tien Hwang, Taipei City (TW)

(73) Assignee: TOPBOUND TECHNOLOGY INC., New Taipei City (TW)

(21) Appl. No.: 13/487,397

(22) Filed: Jun. 4, 2012

(51) Int. Cl. B43K 29/18

(52) U.S. Cl. 401/195

(57) ABSTRACT

The present invention relates to a stylus structure, comprising an outer shell, a touch end, an elastic member, a pen core, and a connecting member, wherein the outer shell consists of a first pen tube, a second pen tube, a pen tip, a clip and a pressing head. The touch end is disposed in the pen tip and connected to the second pen tube, and the touch end is consisted of a conductive layer, a TPU layer and a perforation hole. The elastic member is disposed in the outer shell for connecting the pen core, and the connecting member is connected to the pen core by one end thereof and connected to the pressing head by another end thereof wherein when the pressing head is pressed, the connecting member and the elastic member are driven to push the pen core out of the through hole.

### BACKGROUND OF THE INVENTION

1. Technical Field

The present invention relates to a stylus structure, and more particularly to a stylus structure which's touch-side and writing-side are set on the same end of the stylus, and the touch-side is anti-wear-out.

2. Description of Related Art

With the development of science and technology, many electronic products are developed to touch electronic products, for example, touch display. The touch display includes a touch panel, and a user could operate the touch panel by using his fingers or a stylus. The touch panel could be applied to cell phone, e-book, electronic dictionary, digital camera, GPS, or ATM (Automatic Teller Machine).

According to the technology principle of touch panels, the touch panels can mainly divided into resistive touch panel and capacitive touch panel. The former one is usually operated by stylus, but the latter one can only be operated by the user's fingers. When operating the capacitive touch panel, the accuracy and sensitivity may be affected due to some factors, such as user's finger temperature or too large finger. Therefore, it is able to know that the conventional stylus still includes the shortcomings and drawbacks as follows:

1. The conventional stylus commonly integrated with a writable pen core and a touch end, however the Touch pen nip and the writable pen core are usually disposed on the two end of the stylus; Such conventional stylus framework causes the inconveniences to users in using the stylus to write words in a paper and touch the touch panel.
2. The touch end of conventional stylus is made of conductive material with low wear resistance. Therefore, when the stylus is long-term used, the touch end may be worn out and then generates fine particles or broken holes on the surface thereof. It can easily know that those fine particles or broken holes would damage the screen of the display and affect the screen display. In addition, because the main conductive material of the touch end is corbon with color of black, such that touch end of the conventional stylus looks not pretty.

Accordingly, in view of the shortcoming of the conventional stylus, the inventor of the present application has made great efforts to make inventive research thereon and eventually provided a stylus structure.

### BRIEF SUMMARY OF THE INVENTION

The first objective of the present invention is to provide an improvement for stylus structure, in which the pen core and the touch end are integrated and disposed on one end of the stylus pen tube, and such design brings conveniences to users in using the stylus to write words in a paper and touch the touch panel.

The second objective of the present invention is to provide an improvement for stylus structure, in which a TPU layer (polyurethane) is printed on the touch end to prevent the wear-out or damages, moreover, the surface of TPU layer can also be coated a print layer for modulating the color of the touch end.

Thus, in order to achieve the above-mentioned objectives of the present invention, the inventors propose a stylus structure, comprising: an outer shell having:

a pen tube;
a pen tip, being connected to one end of the pen tube;
a clip, being disposed on another end of the pen tube; and
a pressing head, being connected with the clip.

a touch end, being disposed in the pen tip and connected to the pen tube,

wherein the touch end comprises:
a conductive layer;
a TPU (polyurethane) layer, is on the top surface of the conductive layer; and
a perforation hole, being formed within the conductive layer and the TPU layer for
penetrating through the conductive layer and the TPU layer;
an elastic member, being disposed in the outer shell;
a pen core, being connected to the elastic member; and
a connecting member, being connected to the pen core by one end thereof, and
connected to the pressing head by another end thereof, wherein when the pressing head is pressed, the connecting member and the elastic member being driven to push the pen core 4 out of the perforation hole.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is an exploded diagram of the stylus structure according to the present invention;

FIG. 2 is an appearance diagram of the stylus structure according to the present invention;

FIG. 3 is a motion view of the pen core diagram of the stylus structure according to the present invention;

FIG. 4 is the perspective view of the touch end diagram of the stylus structure according to the present invention;

FIG. 5A is the first thermoforming stylus diagram of the stylus structure according to the present invention;

FIG. 5B is the second thermoforming stylus diagram of the stylus structure according to the present invention; and

FIG. 5C is the third thermoforming stylus diagram of the stylus structure after punching process according to the present invention.

### DETAILED DESCRIPTION OF THE INVENTION

To more clearly describe a stylus structure according to the present invention, embodiments of the present invention will be described in detail with reference to the attached drawings hereinafter.

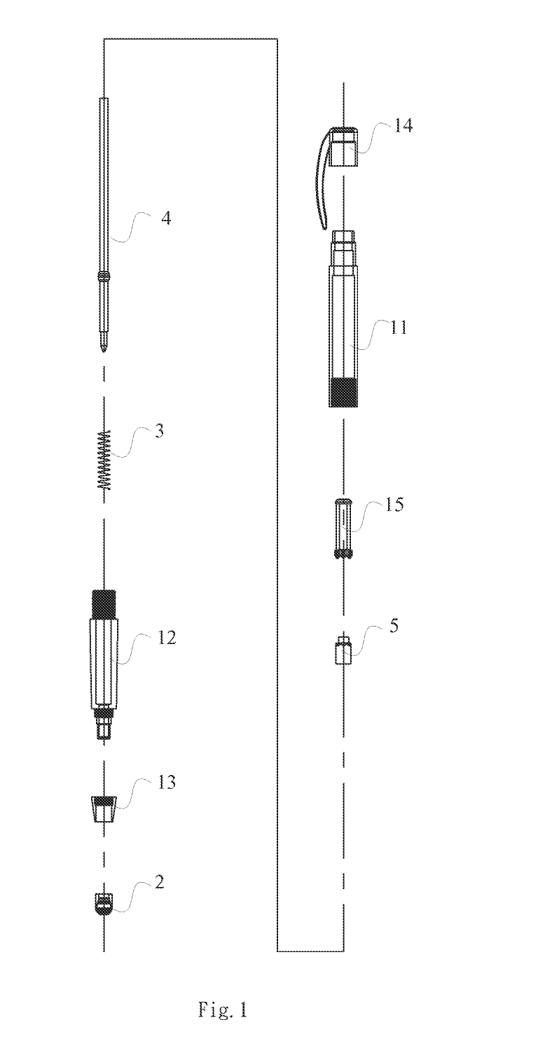

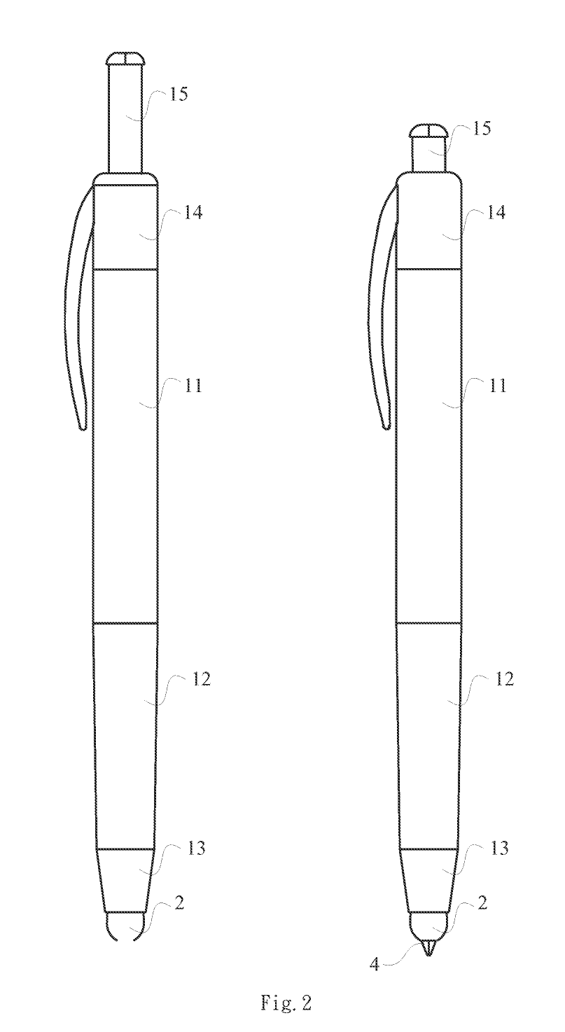

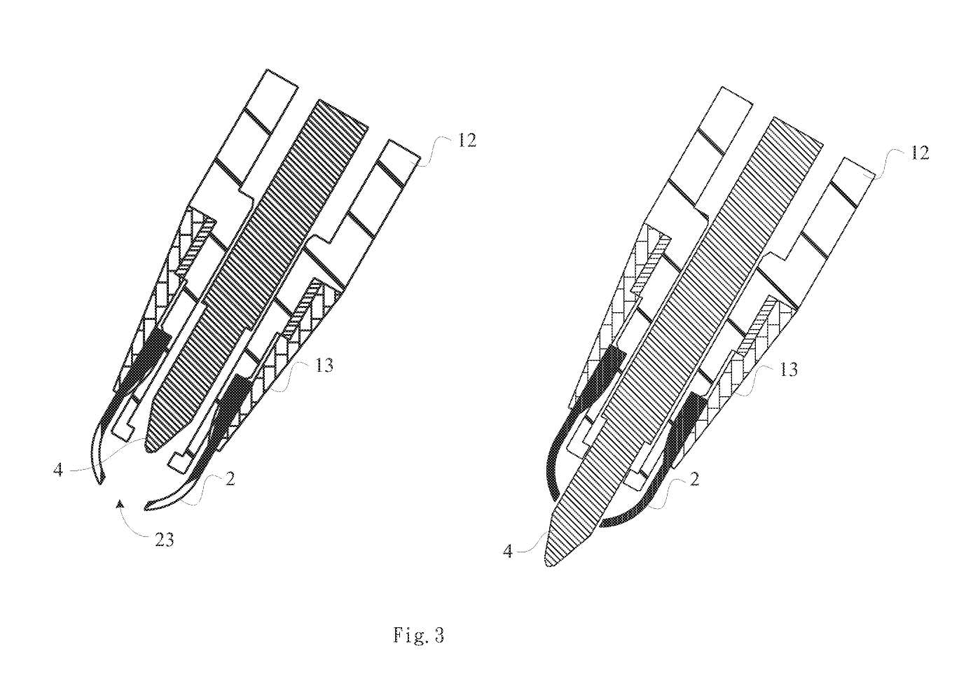

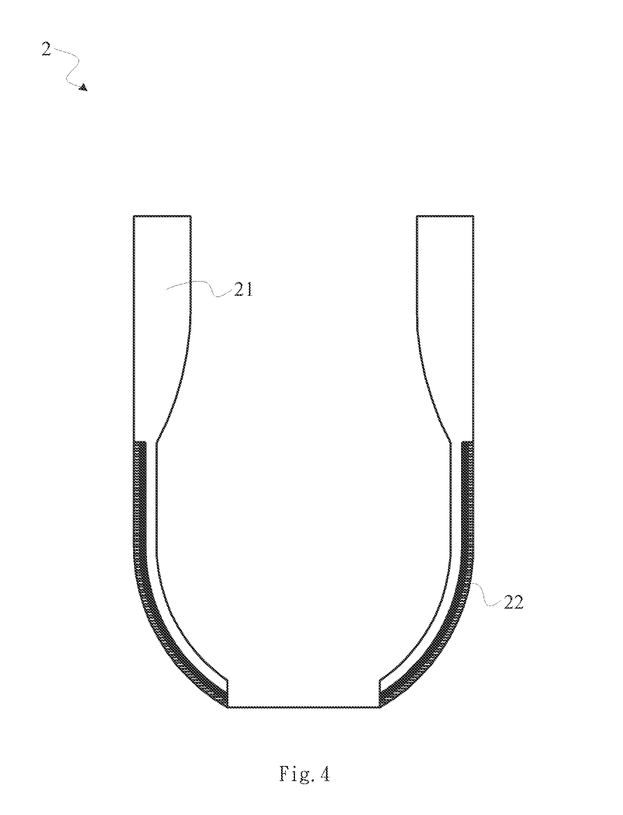

With reference to FIGS. 1-4, there are shown an exploded diagram, an appearance diagram, and a motion view of the pen core diagram, and a perspective view of the touch end diagram of the stylus structure according to the present invention. As shown in FIG. 1, the stylus structure comprises: an outer shell comprising a first pen tube 11, a second pen tube 12 being connected to one end of the first pen tube 11, a clip 14 being disposed on another end of the first pen tube 11, a pen tip 13 being connected to another end of the second pen tube 12, and a pressing head 15 connected with the clip 14; wherein the first pen tube 11 and the second pen tube 12 are made of conductive material.

A touch end 2 which is also made of conductive material, being disposed in the pen tip 13 and connected to the second pen tube 12, wherein the structure of the touch end 2 comprises:

A conductive layer 21 made of conductive rubber; a TPU (polyurethane) layer 22, being formed on the conductive layer 21, wherein the TPU layer 22 has function of anti-wear-out for preventing the broken hole or the wearing out or the chips or the fine particles; a perforation hole 23, being formed within the conductive layer 21 and the TPU layer 22 for penetrating through the conductive layer 21 and the TPU layer 22; moreover, further comprising a print layer formed between the TPU layer 22 and the conductive layer 21, wherein the color of the printing layer can be modulated;

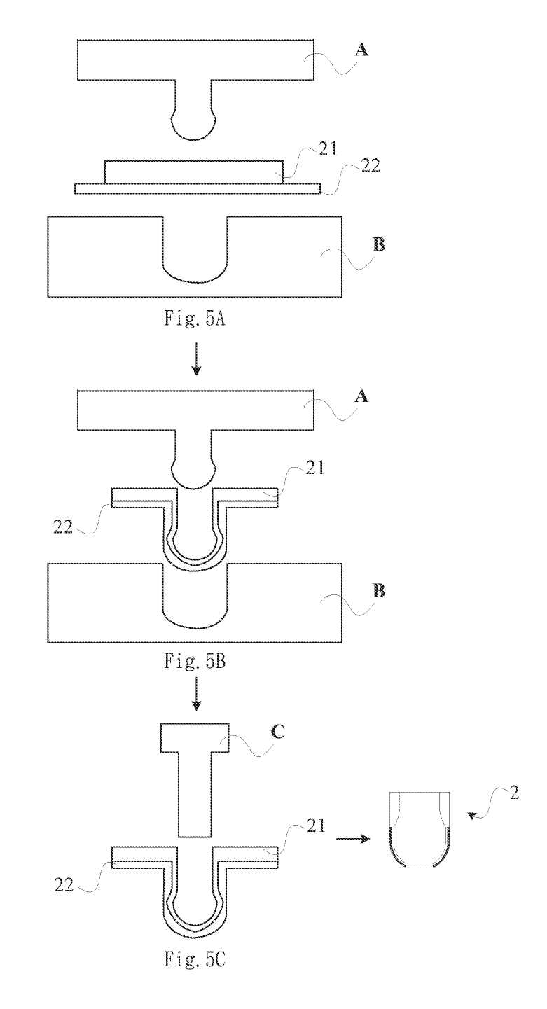

An elastic member 3, being disposed in the outer shell, wherein the elastic member 3 is a spring; a pen core 4, being connected to the elastic member 3, wherein the pen core 4 is selected from the group consisting of refill ink core or graphite core; and a connecting member 5, being connected to the pen core 4 by one end thereof, and connected to the pressing head 15 by another end thereof, wherein when pressing head 15 is pressed, the connecting member 5 and the elastic member 3 being driven to push the pen core 4 out of the through hole 23 or retract the pen core back to pen barrel. In the end, please refer to FIG. 5A, FIG. 5B, and FIG. 5C which illustrate the first, second, and third thermoforming stylus diagram of the stylus structure according to the present invention. As shown in FIG. 5A, the conductive layer 21 is formed on the TPU layer 22, then placing them between a first die (A) and a second die (B), wherein the color of print layer formed between the TPU layer 22 and the conductive layer 21 can be modulated; then as shown in FIG. 5B, After thermoforming by the first die (A) and the second die (B), the conductive layer 21, and the TPU layer 22 would form a cup-shape structure; finally as shown in FIG. 5C, the cup-shape formed by the conductive layer 21, and the TPU layer 22 is punched and perforated by a punching die (C), thus the touch end 2 and the perforation hole 23 of the present invention is formed.

Thus, through the embodiment, the stylus structure of the present invention has been completely and clearly disclosed in the above description, and in summary, the present invention has the following advantages:

1. In the present invention, the pen core and the touch end are integrated and disposed on one end of the stylus pen tube, and the perforation hole disposed on the touch end allows the pen core to be accessed; therefore such design brings conveniences to users in using the stylus to write words in a paper and touch the touch panel.
2. Moreover, in the present invention, the TPU layer(polyurethane) is additionally applied on the touch end to prevent the wear-out or damages, and the surface of TPU layer can also be printed for modulating the color of the touch end.

The above description is made on embodiments of the present invention. However, the embodiments are not intended to limit the scope of the present invention, and all equivalent implementations or alterations within the spirit of the present invention still fall within the scope of the present invention.

I claim:

1. A stylus structure, comprising:
an outer shell having:
a pen tube;
a pen tip, being connected to one end of the pen tube;
a clip, being disposed on another end of the pen tube; and
a pressing head, being connected with the clip;
a touch end, being disposed in the pen tip and connected to the pen tube, wherein the touch end comprises:
a conductive layer;
a TPU (polyurethane) layer, is on the top surface of the conductive layer; and
a perforation hole, being formed within the conductive layer and the TPU layer for penetrating through the conductive layer and the TPU layer;
an elastic member, being disposed in the outer shell;
a pen core, being connected to the elastic member; and
a connecting member, being connected to the pen core by one end thereof, and connected to the pressing head by another end thereof, wherein when the pressing head is pressed, the connecting member and the elastic member being driven to push the pen core out of the perforation hole.

2. The stylus structure of claim 1, wherein the pen tube is made of conductive material.

3. The stylus structure of claim 1, wherein the pen tube is made of conductive material.

4. The stylus structure of claim 1, wherein the conductive layer is made of conductive rubber.

5. The stylus structure of claim 1, further comprising a print layer formed between the TPU layer and the conductive layer, wherein the color of the print layer can be modulated.

6. The stylus structure of claim 1, wherein the elastic member is a spring.

7. The stylus structure of claim 1, wherein the pen core is selected from the group consisting of: refill ink core and graphite core.

8. A stylus structure, comprising:
an outer shell, comprising:
a first pen tube;
a second pen tube, being connected to one end of the first pen tube by one end thereof;
a clip, being disposed on another end of the first pen tube;
a pen tip, being connected to another end of the second pen tube; and
a pressing head, being connected with the clip;
a touch end, being disposed in the pen tip and connected to the second pen tube,
wherein the touch end comprises:
a conductive layer;
a TPU (polyurethane) layer, being formed on the conductive layer; and
a perforation hole, being formed within the conductive layer and the TPU layer for penetrating through the conductive layer and the TPU layer;
an elastic member, being disposed in the outer shell;
a pen core, being connected to the elastic member; and
a connecting member, being connected to the pen core by one end thereof, and connected to the pressing head by another end thereof, wherein when the pressing head is pressed, the connecting member and the elastic member being driven to push the pen core out of the perforation hole.

9. The stylus structure of claim 8, wherein the first pen tube and the second pen tube are made of conductive material.

10. The stylus structure of claim 8, wherein the touch end is made of conductive material.

11. The stylus structure of claim 8, wherein the conductive layer is made of conductive rubber.

12. The stylus structure of claim 8, further comprising a print layer formed between the TPU layer and the conductive layer, wherein the color of the print layer can be modulated.

13. The stylus structure of claim 8, wherein the elastic member is a spring.

14. The stylus structure of claim 8, wherein the pen core is selected from the group consisting of: refill ink core and graphite core.
